(19) United States
(12) Patent Application Publication
(10) Pub. No.: US 2024/0405362 A1
(43) Pub. Date: Dec. 5, 2024

(54) BATTERY MODULE PART

(71) Applicant: LG ENERGY SOLUTION, LTD., Seoul (KR)

(72) Inventors: Byung Do JANG, Daejeon (KR); Hyoung Suk LEE, Daejeon (KR); Ju Hwan SHIN, Daejeon (KR); Jae Hyun LEE, Daejeon (KR); Ki Young KIM, Daejeon (KR)

(73) Assignee: LG ENERGY SOLUTION, LTD., Seoul (KR)

(21) Appl. No.: 18/700,118

(22) PCT Filed: Jul. 4, 2023
(86) PCT No.: PCT/KR2023/009408

§ 371 Date: Apr. 10, 2024

(30) Foreign Application Priority Data
Jul. 7, 2022 (KR) 10-2022-0083860

(51) Int. Cl. H01M 50/383; H01M 50/229; H01M 50/231

(52) U.S. Cl. CPC H01M 50/383; H01M 50/229; H01M 50/231

(57) ABSTRACT

A battery module part includes a body made of synthetic resin and a mesh made of a metal and embedded in the body. The body has a lower melting point than the mesh.

### TECHNICAL FIELD

The present invention relates a battery module part, and more particularly, to a battery module part capable of suppressing the spread of secondary damage such as an external fire or explosion by preventing a flame from being exposed outside a module frame even when a battery cell mounted inside the module frame overheats and generates the flame.

The application claims the benefit of priority based on Korean Patent Application No. 10-2022-0083860 dated Jul. 7, 2022, and all contents disclosed in the document of the Korean Patent Application are included as part of the specification.

### BACKGROUND ART

Unlike primary batteries, secondary batteries can be recharged and have been researched and developed extensively in recent years due to their potential for miniaturization and large capacity. The demand for secondary batteries as energy sources is increasing more rapidly due to technology development and an increase in demand for mobile devices and also due to electric vehicles and energy storage systems that are emerging in line with the needs of the times for environmental protection.

Secondary batteries are classified into coin type batteries, cylindrical type batteries, prismatic type batteries, and pouch type batteries according to the shape of a battery case. An electrode assembly mounted inside a battery case in a secondary battery is a chargeable or dischargeable power generating element consisting of a stacked structure of electrodes and a separator.

Since continuous use of a secondary battery for a long period of time is required, it is necessary to effectively control the heat generated during a charging and discharging process. When a secondary battery is improperly cooled, the resulting rise in temperature leads to an increase in current, which causes a positive feedback chain reaction that causes the temperature to rise again, ultimately triggering a catastrophic state of thermal runaway.

In addition, when secondary batteries are grouped in the form of modules or packs, thermal runaway occurring in one secondary battery causes a thermal propagation phenomenon in which other secondary batteries in the surrounding area are sequentially overheated. Furthermore, when the flame generated from an overheated secondary battery is exposed to the outside, it can not only damage surrounding devices but also spread as secondary damage such as a fire or explosion. Thus, it is necessary to prepare measures against such fire risks.

### RELATED DOCUMENT

(Patent Document 1) Korean Patent Publication No. 2020-0078344 (published on Jun. 1, 2020)

### Technical Problem

The present invention is directed to providing a battery module frame capable of suppressing the spread of secondary damage such as an external fire or explosion by preventing the structural collapse of a frame even when a battery cell mounted inside overheats and generates a flame.

However, the technical problem to be solved by the present invention is not limited to the above-described problem, and other problems not described can be clearly understood by those skilled in the art from the description of the present invention described below.

### Technical Solution

One aspect of the present invention provides a battery module part, and as an example, a batter module part includes a body made of synthetic resin and a mesh made of a metal and embedded in the body, wherein the body has a lower melting point than the mesh.

The mesh may be embedded in the body by insert injection to form an integrated body, and at least a portion of the mesh is exposed on an inner surface of the body.

The body may form an end plate of a battery module frame.

A portion of an outer surface of the body may include a vulnerable portion with a lower heat resistance than a surrounding portion of the outer surface of the body.

The vulnerable portion may be made of a synthetic resin material with a lower melting point than a synthetic resin material of the body or formed to be thinner than a surrounding portion of the outer surface of the body.

The metal of the mesh is stainless steel.

The mesh is embedded in the body by insert injection to form the integrated body, and the mesh is not exposed to the outside of the body.

An inner surface of the body includes at least one first vulnerable portion with lower heat resistance than a surrounding portion of the inner surface of the body, and a portion of an outer surface of the body includes a second vulnerable portion with lower heat resistance than a surrounding portion of the outer surface of the body.

The at least one first vulnerable portion and the second vulnerable portion may each be made of a synthetic resin material with a lower melting point than a synthetic resin material of the body, or formed to be thinner than a surrounding portion.

The at least one first vulnerable portion may be a plurality of first vulnerable portions, and the second vulnerable portion may be provided as a single second vulnerable portion equidistant from the plurality of first vulnerable portions.

The second vulnerable portion may include a filter with denser dimensions than the mesh.

### Advantageous Effects

A battery module part of the present invention having the above configuration is made of a composite material in which a mesh made of a metal is embedded in a body made of synthetic resin. Therefore, when a flame occurs within the battery module, a flame quenching effect is provided through the mesh structure, even when the body made of a resin with a low melting point melts and forms an outlet, only high-temperature gas is discharged and the flame is not discharged to the outside.

Also, the risk of external fire can be further reduced by forming a vulnerable portion in a body and limiting a discharge location of high-temperature gas to the vulnerable portion.

However, the technical effects that can be achieved through the present invention are not limited to the effects described above, and other effects that are not described can be clearly understood by those skilled in the art from the description of the present invention described below.

### BRIEF DESCRIPTION OF THE DRAWINGS

The following drawings attached to this specification illustrate exemplary embodiments of the present invention, and together with the detailed description of the present invention described below, serve to provide further understanding of the technical spirit of the present invention. Therefore, the present invention should not be construed as being limited to the details described in such drawings.

FIG. 1 is a diagram illustrating an example of a battery module including a battery module part according to the present invention.

FIG. 2 is a diagram illustrating a cross-sectional structure of an end plate according to an embodiment of the present invention.

FIG. 3 is a diagram illustrating an example of combining a mesh into a body of an end plate by insert injection.

FIG. 4 is a diagram illustrating an example in which the end plate of FIG. 2 is coupled to a battery module frame.

FIG. 5 and FIG. 6 are diagrams illustrating an example of forming a vulnerable portion in each body.

FIG. 7 is a cross-sectional structure of an end plate according to another embodiment of the present invention.

FIG. 8 is a diagram illustrating a relative arrangement relationship between a first vulnerable portion and a second vulnerable portion.

FIG. 9 is a diagram illustrating an example in which a filter is provided in a second vulnerable portion formed in the end plate of FIG. 7.

### BEST MODES OF THE INVENTION

Since the present invention may be variously changed and have various embodiments, specific embodiments will be described in detail below.

However, it should be understood that there is no intention to limit the present invention to specific embodiments, and on the contrary, the present invention is to cover all modification, equivalents, and alternatives falling within the spirit and scope of the present invention.

In the present invention, it should be understood that terms such as “include” and “have” are intended to indicate the presence of a feature, number, step, operation, component, part, or a combination thereof described in the specification, and they do not preclude the possibility of the presence or addition of one or more other features or numbers, steps, operations, components, parts or combinations thereof.

Also, when a first portion such as a layer, a film, an area, a plate, etc. is referred to as being “on” a second portion, this includes not only the case where the first portion is “directly on” the second portion, but also the case where a third portion is interposed therebetween. On the other hand, when a first portion such as a layer, a film, an area, a plate, etc. is referred to as being “under” a second portion, this includes not only the case where the first portion is “directly under” the second portion, but also the case where a third portion is interposed therebetween. In addition, to be disposed “on” in the present application may include the case disposed at the bottom as well as the top.

One aspect of the present invention provides a battery module part, and as an example, a battery module part includes a body made of synthetic resin and a mesh made of a metal and embedded in the body, wherein the body has a lower melting point than the mesh.

The battery module part of the present invention having the above configuration is made of a composite material in which the mesh made of a metal is embedded in the body made of synthetic resin. Therefore, when a flame occurs within the battery module, a flame quenching effect is provided through the mesh structure, even when the body made of a resin with a low melting point melts and forms an outlet, only high-temperature gas is discharged and the flame is not discharged to the outside.

### MODES OF THE INVENTION

Hereinafter, specific embodiments of a battery module frame of the present invention will be described in detail with reference to the attached drawings. For reference, front and rear directions or up, down, left, right directions for designating relative positions used in the following description are intended to help the understanding of the present invention and are based on directions shown in the drawings unless otherwise specified.

### First Embodiment

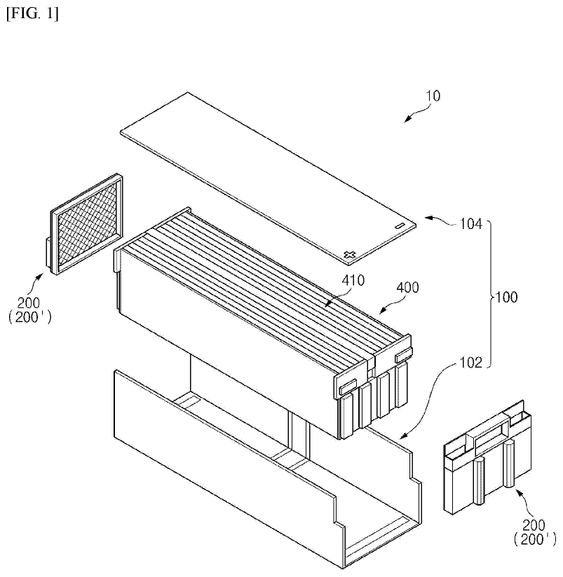

FIG. 1 is a diagram illustrating an example of a battery module 10 including a battery module part 200 according to the present invention. The battery module 10 refers to a battery assembly in which a certain number of battery cells 410 are combined and placed in a frame to protect the battery cells from external impacts, heat, vibrations, etc. The battery module 10 includes a plurality of battery cells 410 connected in series and/or parallel, and is embedded in a mechanical structure, that is, a battery module frame 100.

Each battery cell 410 plays a fundamental role in storing energy and supplying the energy to an external device when needed. However, since each battery cell has a small capacity, a module is made by combining the battery cells, and further, the modules are combined to make a battery pack.

The present invention relates to the battery module part 200 applied to a battery module 10 that protects a plurality of battery cells 410. The battery module 10 illustrated as an example in FIG. 1 includes a battery cell assembly 400 in which the plurality of battery cells 410 are connected in series and/or parallel to form one assembly.

In addition, the battery module frame 100, which is a mechanical structure that protects the plurality of battery cells 410, includes a main frame 102, which has a “U”-shaped cross section and has a space for accommodating the battery cell assembly 400 therein, and an upper plate 104 covering an open upper surface of the main frame 102. Here, an end plate 200′ is coupled to both open sides of the battery module frame 100 to seal the battery module 10. In the present invention, the end plate 200′ is exemplified as one battery module part 200.

The battery module 10 has a polyhedral shape that accommodates a plurality of battery cells 410, e.g., a hexahedral shape in FIG. 1, and the end plates 200′ are coupled to both sides of the battery module 10. Here, the end plate 200′ is coupled to an electrode lead side of the battery cell assembly 400, and accordingly, the end plate 200′ may include a busbar that is electrically connected to the battery cell assembly 400.

Therefore, in the case of the end plate 200′ including a busbar, the end plate 200′ may be called a busbar frame. Therefore, the end plate 200′ referred to in the specification of the present invention needs to be broadly understood as a battery module part 200 that seals both sides of the battery module 10, without being limited by the usage of the term.

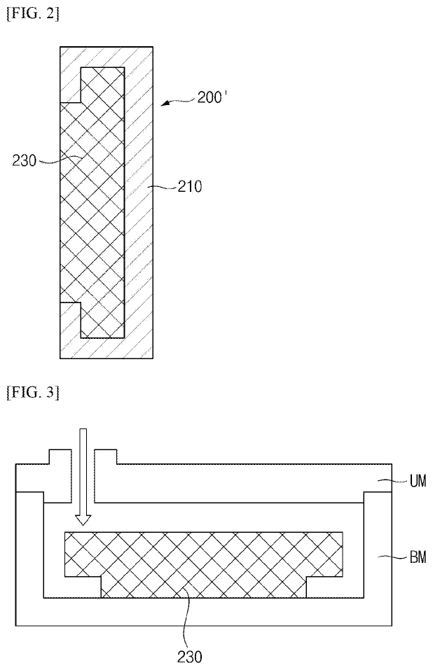

FIG. 2 illustrates a cross-sectional structure of a battery module part 200, that is, an end plate 200′, according to a first embodiment of the present invention. The end plate 200′ includes a body 210 made of synthetic resin and a mesh 230 made of a metal and embedded in the body 210. In particular, the body 210 made of synthetic resin has a lower melting point than the mesh 230 made of a metal.

That is, the end plate 200′ of the present invention is made of a composite material in which the body 210 made of synthetic resin and the mesh 230 made of a metal and embedded in the body 210 are combined. Here, the body 210 made of synthetic resin serves as a structure that maintains the mechanical structure of the end plate 200′. Therefore, the body 210 may be made of synthetic resin with excellent mechanical strength, for example, polycarbonate.

Further, the mesh 230 contained within the body 210 made of synthetic resin may be understood as a porous metal body in a broad sense. For example, a metal net, a wire mesh, a metal thin film with a plurality of through holes, etc. may be applied as the mesh 230. Alternatively, a flat mass of wire wound with a thin metal thread in a spiral shape may be inserted into the mesh 230 made of a metal.

The end plate 200′ of the present invention uses the body 210 made of synthetic resin as a structure and includes a porous mesh 230 therein. Therefore, a lightweight battery module part 200 may be implemented through weight reduction using synthetic resin materials and weight reduction through the mesh 230 structure.

In addition, the end plate 200′ of the present invention not only allows the mesh 230 made of a metal and embedded in the body 210 to split into small pieces while the flame generated during thermal runaway of a battery cell 410 passes through the mesh, but also causes an endothermic reaction that absorbs the energy of the flame, resulting in a temperature drop and a flame quenching effect.

More specifically, since the mesh 230 made of a metal has a plurality of small holes, gases such as gas or steam may easily pass through the mesh 230, but it is relatively difficult for flames to pass through the plurality of small holes.

When the mixture of combustible gas and air inside the battery cell 410 ignites, the mesh 230 inside the end plate 200′ absorbs and dissipates heat generated from the burning gas mixture, thereby lowering a combustion temperature to prevent the surrounding gas from reaching its spontaneous ignition temperature. This is because heat is lost to the porous structure of the metal material as the high-temperature gas passes through the mesh 230. That is, the mesh 230 is made of a metal material containing numerous holes and functions as a flame arrester with a very large cross-sectional area.

Accordingly, the flame generated by the thermal runaway of the battery cell 410 loses enough heat to no longer be maintained as it passes through the battery module part 200 of the present invention, thereby effectively suppressing a heat propagation phenomenon or external fire.

In addition, since the body 210 made of synthetic resin has a lower melting point than the mesh 230 made of a metal, the flame passing through the mesh 230 melts a part of the outer surface of the body 210 during the process of losing heat, forming a through hole. Nevertheless, since the flame is almost eliminated by the mesh 230, which functions as an ignition prevention net, high-temperature gas is mainly discharged through the through hole of the body 210 formed by melting by the flame, and almost no flame is discharged.

Meanwhile, the mesh 230 made of a metal needs to have heat-resistant properties in order to maintain its flame quenching function for a long time. In addition, it is preferable that the mesh 230 be selected from a material that has not only a flame quenching ability to suppress flames but also mechanical properties that may withstand explosion pressure. Therefore, steel or stainless steel, which has heat resistant and excellent mechanical strength, may be selected as the material for the mesh 230.

For example, the mesh 230 may be made of heat-resistant stainless steel. The heat-resistant stainless steel is a ferritic stainless steel alloy such as X10CrAlSi7, X10CrAl13, X10CrAl18 or X18CrN28, or an austenitic stainless steel alloy such as X15CrNiSi20-12, X15CrNiSi25-20, X15CrNiSi25-21 or X12CrNiTi18-10, or a nickel-chromium stainless steel alloy such as NiCr15Fe, NiCr23Fe, NiCr22Mo9Nb, NiCr21Mo or NiCr28FeSiCe.

Additionally, since the mesh 230 embedded in the body 210 is in a thin plate type, an increase in the size of the battery module 10 may be suppressed. Also, since the mesh 230 has a plurality of holes, an increase in weight may be suppressed. In addition, while the battery module part 200 of the present invention may suppress an increase in the size or weight of the battery module 10 and a battery pack in which the battery module 10 is assembled, even when a flame erupts from the battery cell 410, the safety of the battery module 10 is improved by preventing the ejection of the flame to the outside.

In one embodiment of the present invention, the mesh 230 may be embedded in the body 210 by insert injection to form an integrated body. FIG. 3 exemplarily shows a process of manufacturing a battery pack part by injecting melted synthetic resin while the mesh 230 is fixed in a mold including an upper mold UM and a bottom mold BM.

Additionally, according to the embodiment of FIG. 3, since the mesh 230 is fixed in close contact with the bottom surface of the bottom mold, at least a portion of the mesh 230 is exposed on an inner surface of the body 210 of the end plate 200′ as illustrated in FIG. 2. In order to embed and fix the mesh 230 in the body 210, a step for injection of the melted synthetic resin is formed on a portion of the mesh 230. However, the portion of the mesh 230 in close contact with the bottom surface of the bottom mold forms an exposed surface on the inner surface of the body 210.

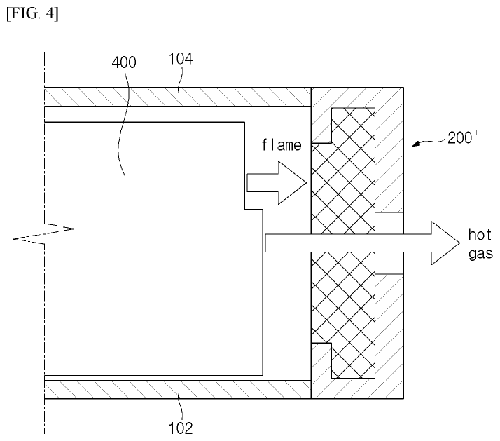

An example in which the end plate 200′ of FIG. 2 is coupled to the battery module frame 100 is illustrated in FIG. 4. In the battery module 10 of FIG. 4, when a fire occurs in the battery cell 410, as the mesh 230 of the end plate 200′ is exposed on the inner surface of the body 210, the flame quenching ability of the mesh 230 is exerted to block the flame when the expanding flame reaches the mesh 230. Therefore, even when a through hole is generated on the outer surface of the body 210 due to high temperature, only high temperature gas is mainly discharged and the flame is not ejected outside the end plate 200′.

However, where the through hole occurs in the end plate 200′ is random. In other words, depending on a location of the flame or a shape of the end plate 200′, the through hole is formed in a part that is vulnerable to heat. Even when flame does not burst through the through hole, high-temperature gas is discharged. Therefore, when there are devices or parts vulnerable to high-temperature gas or flammable near the through hole, this may cause an external fire or secondary damage.

Therefore, according to one embodiment of the present invention, by providing a vulnerable portion 220 than the surrounding portion on a portion of the outer surface of the body 210, a through hole may be induced to be formed in the vulnerable portion 220. In other words, an appropriate location of the through hole through which the high-temperature gas is discharged may be limited to the vulnerable portion 220.

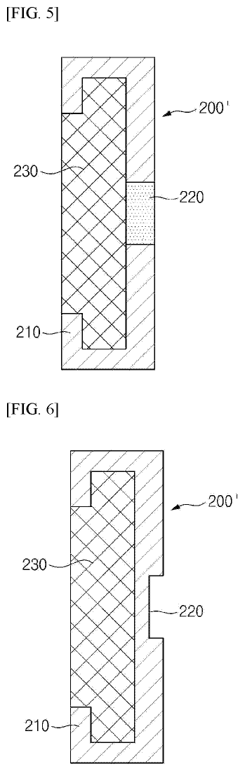

The vulnerable portion 220 can be designed in various ways. For example, as shown in FIG. 5, a different synthetic resin material with a lower melting point than the body 210 is inserted into the body 210 to form the vulnerable portion 220, or as shown in FIG. 6, a thickness of the vulnerable portion 220 may be formed thinner than the surrounding portion so that it melts faster even when it receives the same heat. However, since FIGS. 5 and 6 relate to exemplary methods for forming the vulnerable portion 220, the specific configuration of the vulnerable portion 220 is not limited by the exemplary methods.

### Second Embodiment

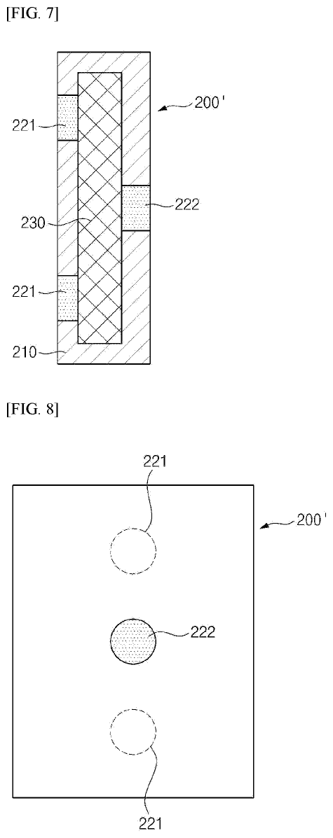

FIG. 7 is a diagram illustrating an end plate 200′ according to the second embodiment of the present invention. According to the second embodiment of FIG. 7, a mesh 230 is embedded in a body 210 through insert injection to form an integrated body, and the mesh 230 is not exposed to the outside of the body 210.

That is, the end plate 200′ of the second embodiment has a structure in which the mesh 230 is fully embedded in the body 210, and the mesh 230 is not exposed anywhere on an outer surface as well as an inner surface of the body 210. Therefore, when a fire occurs inside the battery module 10, a high temperature flame melts the inner surface of the body 210, the flame flows into the mesh 230 when the mesh 230 is exposed, and the mesh 230 exerts a flame quenching function to block the flame.

The end plate 200′ of the second embodiment has the advantage of being structurally stronger because there is no cut surface exposing the mesh 230 in the body 210. Therefore, the second embodiment may be a more suitable embodiment when the size and weight of the battery module 10 are large.

However, in the second embodiment, the flame quenching function does not work immediately because the mesh 230 is exposed after the high temperature flame melts the inner surface of the body 210, and where a through hole is formed in the inner surface of the body 210 is random. Therefore, as shown in FIG. 7, it may be preferable to provide a first vulnerable portion 221, which has lower heat resistance than the surrounding portion, on the inner surface of the body 210 to induce the through hole to be formed in the first vulnerable portion 221.

Additionally, as described in the first embodiment, as a second vulnerable portion 222, which has lower heat resistance than the surrounding portion, is formed on a portion of the outer surface of the body 210, an appropriate location of the through hole through which high-temperature gas is discharged may be limited to the second vulnerable portion 222. In addition, the first vulnerable portion 221 and the second vulnerable portion 222 may each be made of a different synthetic resin material with a lower melting point than the body, or may be formed to be thinner than the surrounding portion. FIG. 7 illustrates an embodiment in which the first vulnerable portion 221 and the second vulnerable portion 222 are made of a different synthetic resin material with a lower melting point than the body 210.

Additionally, FIG. 8 is a diagram illustrating a relative arrangement relationship between a first vulnerable portion and a second vulnerable portion. A plurality of first vulnerable portions 221 are provided, and one second vulnerable portion 222 is provided and arranged equidistant from the plurality of first vulnerable portions 221. This is to ensure that the flame quenching action of the mesh 230 may be sufficiently exerted by allowing the flame entering the first vulnerable portion 221 to be discharged to the second vulnerable portion 222 after traveling as long as possible.

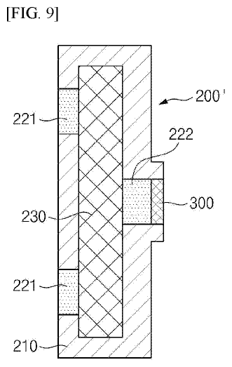

FIG. 9 illustrates a configuration in which a filter 300 with denser dimensions than the mesh 230 inside the body 210 is provided in the second vulnerable portion 222 in the end plate 200′ of the second embodiment. When the flame that has passed through the mesh 230 bursts through the second vulnerable portion 222, almost no flame remains and is discharged in the form of a high-temperature gas. The high-temperature gas may include high-temperature particles that may act as an ignition source for an external fire.

The embodiment of FIG. 9 is intended to prevent fires caused by high-temperature particles, and the filter 300 provided in the second vulnerable portion 222, and in particular, a filter 300 that is denser than the mesh 230 is provided in the second vulnerable portion 222 so that particles having the same size as that of particles passing through the mesh 230 may be filtered, thereby preventing the risk of external fires more effectively.

In the above, the present invention has been described in more detail through drawings and examples. However, since the configurations described in the drawings or examples described in the specification are only one embodiment of the present invention and do not represent the entire technical idea of the present invention, it should be understood that, there may be various equivalents and variations at the time of filing this application.

### DESCRIPTION OF REFERENCE NUMERALS

| | |
|---|---|
| 10: battery module | 100: battery module frame |
| 102: main frame | 104: upper plate |
| 200: battery module part | 200′: end plate |
| 210: body | 220: vulnerable portion |
| 221: first vulnerable portion | 222: second vulnerable portion |
| 230: mesh | 300: filter |
| 400: battery cell assembly | 410: battery cell |
| UM: upper molding | BM: bottom molding |

1. A battery module part comprising:
a body made of synthetic resin; and
a mesh made of a metal and embedded in the body,
wherein the body has a lower melting point than the mesh.

2. The battery module part of claim 1, wherein the mesh is embedded in the body by insert injection to form an integrated body, and
at least a portion of the mesh is exposed on an inner surface of the body.

3. The battery module part of claim 1, wherein the body forms an end plate of a battery module frame.

4. The battery module part of claim 2, wherein a portion of an outer surface of the body includes a vulnerable portion with a lower heat resistance than a surrounding portion of the outer surface of the body.

5. The battery module part of claim 4, wherein the vulnerable portion is made of a synthetic resin material with a lower melting point than a synthetic resin material of the body or formed to be thinner than a surrounding portion of the outer surface of the body.

6. The battery module part of claim 1, wherein the metal of the mesh is stainless steel.

7. The battery module part of claim 1, wherein the mesh is embedded in the body by insert injection to form the integrated body, and the mesh is not exposed to an outside of the body.

8. The battery module part of claim 7, wherein an inner surface of the body includes at least one first vulnerable portion with lower heat resistance than a surrounding portion of the inner surface of the body.

9. The battery module part of claim 8, wherein a portion of an outer surface of the body includes a second vulnerable portion with lower heat resistance than a surrounding portion of the outer surface of the body.

10. The battery module part of claim 9, wherein the at least one first vulnerable portion and the second vulnerable portion are each made of a synthetic resin material with a lower melting point than a synthetic resin material of the body or formed to be thinner than a surrounding portion.

11. The battery module part of claim 9, wherein:
the at least one first vulnerable portion is a plurality of first vulnerable portions; and
the second vulnerable portion is provided as a single second vulnerable portion equidistant from the plurality of first vulnerable portions.

12. The battery module part of claim 9, wherein the second vulnerable portion includes a filter with denser dimensions than the mesh.
